(19) United States
(12) Patent Application Publication
(10) Pub. No.: US 2005/0214495 A1
(43) Pub. Date: Sep. 29, 2005

(54) Adhesive applicator article

(75) Inventor: Laure Thiebaut, Clichy (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 11/079,359

(22) Filed: Mar. 15, 2005

Related U.S. Application Data
(60) Provisional application No. 60/555,309, filed on Mar. 23, 2004.

(30) Foreign Application Priority Data
Mar. 15, 2004 (FR) 0450516

(51) Int. Cl. B32B 9/00

(52) U.S. Cl. 428/40.1; 156/247

(57) ABSTRACT

An article for the application of a cosmetic product, particularly a makeup or skin care product, including at least one applicator having a first face constituting an application surface and a second face, opposite the first. The second face is at least partially covered by an adhesive layer, and the first face holds the product to be applied. A backing sheet covers the adhesive layer, before the first use, and the backing sheet includes a weakened zone or a cutout extending at least partially beneath the applicator and enables the sheet to be separated into at least two parts. The backing sheet projects beyond the applicator on at least one part of its periphery on each side of the weakened zone or the cutout.

### CROSS REFERENCE TO RELATED APPLICATIONS

This document claims priority to French Application Number 04 50516, filed Mar. 15, 2004 and U.S. Provisional Application No. 60/555,309, filed Mar. 23, 2004, the entire contents of which are hereby incorporated by reference.

### BACKGROUND OF THE INVENTION

1. Field of the Invention

The present invention relates to product applicators, and can be particularly advantageous for applying cosmetic products. In a preferred form, the applicator can be adhered to a finger to facilitate application of the product on a surface to be treated.

2. Discussion of Background

The expression “cosmetic product” is understood to mean a product such as defined in Council Directive 93/35/CEE dated 14 Jun. 1993, amending Directive 76/768/CEE for the sixth time.

Applicators exist that have a substantially flat shape and which incorporate a layer of adhesive enabling them to be attached to a finger for the purpose of applying a product. Such an applicator is described in patent application EP 1 374 718.

Generally, the adhesive surfaces are covered by a backing sheet intended to protect the adhesive, and the applicator is lifted off the backing sheet before use. To facilitate the lifting of such applicators off the backing, it is known to place them in a dispenser. Patent application EP 1 374 718 describes for example several applicators attached to a backing tape which is wound onto a dispenser. Such a dispenser is more suitable for dispensing a relatively large quantity of applicators attached to a relatively long strip enabling it to be wound onto the dispenser.

Patent application EP 0 460 649 also describes known adhesive labels that are partially superimposed one upon the other. The labels are thus wound onto a dispenser, with no additional backing tape or with only a thread attached to the adhesive face of the labels to connect them together and to thereby facilitate their separation. Here again, such an arrangement is more suited to the dispensing of a relatively large quantity of labels capable of being wound on the dispenser. Moreover, the labels are intended to be picked up automatically on a production line by an arm which presses on the face opposite the adhesive face of the label so as to detach it from the label which is contiguous therewith and to attach it to a bottle. This type of arrangement is not suited to product applicators intended to be attached to a fingertip. Furthermore, it is necessary to press on the face opposite the adhesive face in order to separate two labels, so that such an arrangement is not suited to applicators wherein the face opposite the adhesive face is intended to be applied to the skin. In effect there is a risk that this surface will become soiled, and when the applicator holds a product to be applied there is a risk of removal of the product.

Also, certain adhesive articles are intended to be packaged individually with a detachable backing to protect their adhesive face. This applies particularly in the case of dressings which incorporate a backing divided into two parts which overlap to form a grasping zone. To detach the dressing from its backing, it is necessary to grasp the article in one hand placing a finger on each of its faces and to then fold the item to allow the grasping zone to be held in order to detach it. For this type of article, this does not pose a problem insofar as the dressing does not hold a product. However, in the case of product applicators, it is preferable to not touch the application face at the risk of contaminating the surface and soiling the fingers. In addition, when the product is disposed at the surface, particularly in the form of a layer of powder, there is a risk that the product layer will break up if the article is folded.

U.S. Pat. Nos. 5,713,842 and 5,840,052 also describe dressings that are intended to be attached to an area of the human body in order to protect it.

### SUMMARY OF THE INVENTION

One of the objects of the invention is therefore to provide an adhesive applicator which at least partially avoids the drawbacks of the prior art.

Another object of the invention is to provide an adhesive applicator that is convenient to use.

A further object of the invention is to provide such an article that can be readily grasped without damaging its application surface.

It is also an object of the invention to provide such an article that can be readily grasped without risk of soiling the fingers.

According to the invention, these objects can be achieved by providing an article for the application of a cosmetic product, particularly a makeup or skin care product, which includes at least one applicator having a first face providing an application surface and a second face, opposite the first, at least partially covered by an adhesive layer. The first face holds the product to be applied. In addition, a backing sheet covers the adhesive layer before the first use. The backing sheet includes a weakened zone or a cutout extending at least partially beneath the applicator and enables the sheet to be separated into at least two parts. Further, the backing sheet projects beyond the applicator on at least one part of its periphery on each side of the weakened zone or the cutout.

The two portions of the backing sheet which project beyond the applicator thus form grasping zones which can be held in order to pick up the article without touching the application surface. A part of the backing sheet can then be detached from the applicator by separating this part from the other part of the sheet by virtue of the weakened zone or cutout. The adhesive face is then partially released to allow the user to place the fingers of one hand thereon, while the other hand continues to hold the portion of the backing sheet projecting beyond the applicator. The applicator can thus be readily attached to one or more fingers to facilitate the application of the product, while avoiding or reducing the risk of damaging the application surface.

By way of example, the backing sheet can project beyond the applicator around its entire periphery. The user thus has the possibility of grasping the backing sheet at several points.

The backing sheet can be a medium treated with silicone, for example, a silicone paper.

Also by way of example, the weakened zone can be a thinner area of the sheet extending along a line which can be continuous or discontinuous. The cutout can also extend along a line which can be continuous or discontinuous.

The weakened zone and the cutout can extend along a straight line and/or along a curved line.

The applicator can be impregnated with a product to be applied and/or the application surface of the applicator can be coated with a layer of a product to be applied.

The applicator can be used with various products, and is particularly advantageous where the product is a cosmetic product.

By way of example, the applicator can be made of a porous or fibrous material, for example a thermoplastic foam material, sponge, felt, non-woven material, or a woven material, for example, of natural fibers such as cotton.

Also by way of example, the applicator can be made of an elastically deformable material so as to obtain a relatively flexible application.

The applicator can also be, for example, a multilayer structure.

The arrangement can also include a number of other optional advantageous features. For example, the application surface can be covered with a flock material, a non-woven or a woven material. The adhesive layer can include a hypoallergenic adhesive. The adhesive layer can extend over the entire face of the applicator opposite the application surface. Alternatively, the adhesive layer can partially cover the applicator face opposite the application surface.

Also by way of example, in a cross-section through the thickness, the applicator can have a flattened shape, with the adhesive layer extending substantially parallel to the application surface. Alternatively, in a cross-section through the thickness, the applicator can have a convex shape, at least on the application surface side. When viewed frontally or in a plain view, the article can have a circular shape, or alternatively a non-circular shape, such as a generally triangular, polygonal, oval, droplet or almond shape.

An article can also be arranged to include several applicators.

Before the first use, the article can be contained, for example, in a sachet. As an alternate example, before use, the application surface can be covered by a film reversibly attached to the portion of the backing sheet projecting beyond the applicator.

According to another aspect, the invention provides a method of applying a cosmetic product with an article such as that just described. The method includes grasping the article on both sides of the weakened zone or cutout by the parts of the backing sheet which extend beyond the applicator. The two parts of the backing sheet are then separated by detaching one of the two parts from the applicator so as to partially expose the adhesive layer. One or more fingers are then placed on the exposed adhesive layer, and the other of the two parts of the backing sheet is pulled off the applicator. The application surface is then applied to the area to be treated.

The article according to the invention is particularly useful for the application of a cosmetic product, such as a disinfectant product, a sunscreen, a moisturizing product, an anti-wrinkle product, a nail varnish, a foundation, a blusher, an eyeshadow, a lip color, a makeup remover, a hair care product, a hair coloring product, a deodorant or antiperspirant product, or a perfume.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

The invention will become further apparent from the following detailed description, particularly when considered in conjunction with the drawings in which:

FIG. 1 illustrates a perspective view of a first embodiment of an article according to the invention;

FIG. 2 shows a cross-section of the article in FIG. 1;

FIG. 3 illustrates a bottom view of the article in FIG. 1;

FIGS. 4 and 5 illustrate different steps involved in the use of the article in FIG. 1;

FIGS. 6A to 11 illustrate variants of the article according to the invention.

### DETAILED DESCRIPTION OF THE PREFERRED EMBODIMENTS

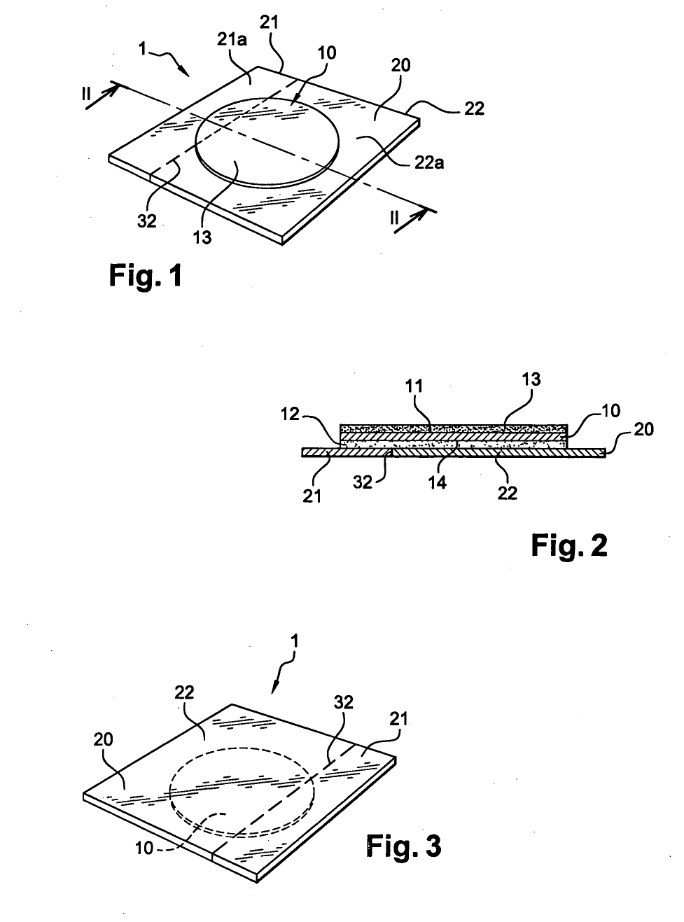

The article 1 for application of a cosmetic product depicted in FIGS. 1 to 5 includes an applicator 10 incorporating an application surface 11 serving to apply a product to the skin, mucous membranes or other external parts of the body. The applicator 10 also includes a face 14 covered with an adhesive layer 12, with the adhesive layer being covered, before the first use, with a backing sheet 20.

By way of example, the applicator 10 is composed of a Micropore® film marketed by 3M Sante. The material is preferably elastically deformable so as to obtain a relatively flexible application.

As a variant, the applicator can include, for example, a layer of a porous or fibrous material, such as an open or closed-cell foam or any other cellular structure, particularly natural or synthetic sponge, or felt or fibrous structures, such as cotton or textile materials. The applicator can alternatively include plural superimposed films and/or layers of porous or fibrous materials.

The applicator 10 is preferably of limited and substantially constant thickness, imparting a flattened shape thereto. For example the applicator can have a thickness of approximately 0.2 mm.

In the example shown, the applicator 10 presents a circular shape when viewed frontally (or in other words, viewing the face of the applicator). It has a diameter of 45 mm, for example. Such an applicator is particularly suitable for the application of a product to the entire face, such as a foundation, in that it can be held by several fingers, for example three fingers. For eyeshadow applicators the use of a smaller applicator is preferred, with a diameter of approximately 15 mm, with the applicator is attached to one fingertip only.

Alternatively, when viewed frontally, the applicator 10 can have a shape other than circular, for example to enable a product to be applied more easily or more precisely to a given part of the face, for example the eyelids or lips. For example, FIGS. 6A to 6E show frontal views of different examples of possible shapes. It is to be understood that other shapes could also be used. When viewed frontally, the applicator 10 can have a shape that is substantially square (FIG. 6A), oval (FIG. 6B), triangular (FIG. 6C), almond shaped (FIG. 6D) or drop shaped (FIG. 6E).

On one side, the applicator 10 defines an application surface 11 intended to be applied to an area to be treated. In the example shown, the applicator 10 presents a flat application surface. Alternatively, the application surface 11 can be curved, for example, with outwardly convex shape.

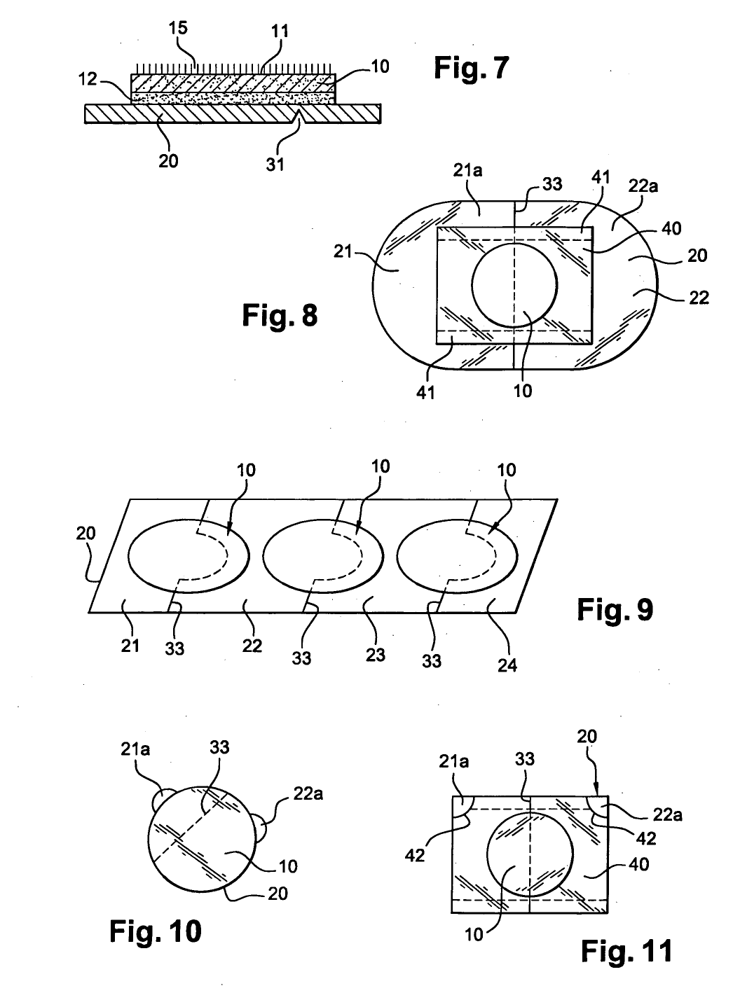

In the example illustrated in FIG. 7, the application surface 11 incorporates a flock material 15. As another example, the application surface can be covered in a non-woven or woven material.

According to the example in FIGS. 1 to 5, the application surface 11 is coated with a layer of product 13, and the product can be a powder deposited by screen printing. The product is for example a lip color, an eyeshadow, a foundation, a blusher, etc.

Alternatively, the applicator 10 can be impregnated with the product. This applies, for example, to the applicator depicted in FIG. 7. In this example, the applicator is made of a porous material, for example foam, which is impregnated with the product to be applied.

Opposite the application surface 11, the applicator 10 includes a face 14 covered with an adhesive layer 12. The adhesive can be, for example, a permanent, water-resistant, hypoallergenic adhesive which adheres more strongly to the applicator than to the skin. The adhesive layer 12 can be in the form of a film which can cover the entire face 14 of the applicator. The adhesive layer can also be provided on only a portion of the applicator, for example, in the form of a pattern of points, a series of strips, or may extend only in the central region of the face 14. The adhesive layer can also be covered, for example, by a mesh to reduce its bonding capacity.

Before the first use, the adhesive layer 12 is covered by a backing sheet 20. The sheet 20 is made for example of silicone-treated paper or polyethylene film.

The backing sheet 20 includes a cutout 32 partially located under the applicator 10 and which divides the sheet into two parts 21 and 22.

In the example illustrated in FIGS. 1 to 5, the cutout 32 is a line cut in a discontinuous manner, i.e. a dotted line of perforations, with the two parts 21 and 22 being attached by uncut portions.

Alternatively, the cutout can be a line 33 cut in a continuous manner completely separating the sheet 20 into two parts 21 and 22, as in the examples illustrated in FIGS. 6A to 6E and 8 to 11.

In another embodiment, the backing sheet can include a weakened zone 31, i.e. a line of reduced thickness relative to the rest of the sheet 20, as depicted in FIG. 7.

The cutout or weakened zone can extend along a straight line as in the examples shown in FIGS. 1, 6A, 6D, 6E, 8 and 10, or alternatively along a curved line as in the examples shown in FIGS. 6B and 6C. In a further alternative, the cutout or weakened zone can extend along a partially straight and partially curved line as illustrated in FIG. 9.

In the example illustrated in FIGS. 1 to 5, the two parts 21 and 22 are of unequal size, being thereby capable of exposing a relatively large part of the adhesive surface sufficient for the applicator to remain held on the fingers. In the example shown, the first part 21 covers approximately a quarter of the applicator 10 and the second part 22 covers approximately three quarters of the applicator. The cutout or weakening line can alternatively divide the sheet into two equal parts, so that each part 21 and 22 covers half the applicator, as in the examples shown in FIGS. 8 and 11.

In the example depicted in FIGS. 1 to 5, the backing sheet 20 is square in shape and projects beyond the applicator 10 over its entire periphery. Alternatively, the backing can be arranged so that the backing sheet 20 projects beyond the applicator on only part of its periphery as shown in FIG. 10. In all cases, the sheet 20 projects beyond the applicator 10 by at least two portions 21a and 22a located on either side of the cutout or weakened zone, so that a user is able to grasp the sheet in at least two areas on both sides of the cutout or weakened zone.

To protect the product layer 13 and the application surface, the applicator 10 can be packaged in a sachet, for example.

Alternatively, the applicator 10 can be covered, as shown in FIG. 8, with a film 40, particularly a polypropylene or PVC film, reversibly attached to the portion of the backing sheet 20 projecting beyond the applicator 10. The film is fixed to the sheet for example by two lines of adhesive 41. In this embodiment, the sheet 20 projects not only beyond the applicator 10, but also beyond the film 40 so that the user is able to grasp the sheet 20 by at least two portions 21a and 22a. It can also be arranged that the film 40 does not project beyond the backing sheet but incorporates two notches 42 allowing two portions 21a and 22a of the backing sheet to be exposed as can be seen in FIG. 11.

In a variant illustrated in FIG. 9, the article includes several applicators 10 attached to the same backing sheet 20. The sheet includes for example three applicators 10 and an equivalent number of cutouts 33. The cutouts 33 then divide the sheet into four parts 21, 22, 23 and 24, which can be successively separated when the applicators are used.

In an example of a method of producing the article 1 illustrated in FIGS. 1 to 5, a dotted line 32 is cut in a sheet 20. A double-sided adhesive is then applied to the sheet 20, and a Micropore® film coated with product is applied to the adhesive.

A die-cutter is then used to cut out the film layer and the adhesive layer, in the desired shape of the applicator, having first positioned the assembly to be cut so that the applicator is straddling the dotted cut-line. The article is then trimmed to remove the unwanted portions of the film and adhesive layer so as to obtain the item illustrated in FIG. 1.

In a variant of the method of producing the article 1, a double-sided adhesive is applied to a sheet 20 and a Micropore® film 10 to the adhesive. A dotted line 32 is cut in the sheet 20 and the application surface of the film 10 is then coated with product. The film and the double-sided adhesive are then cut to the desired shape of the applicator.

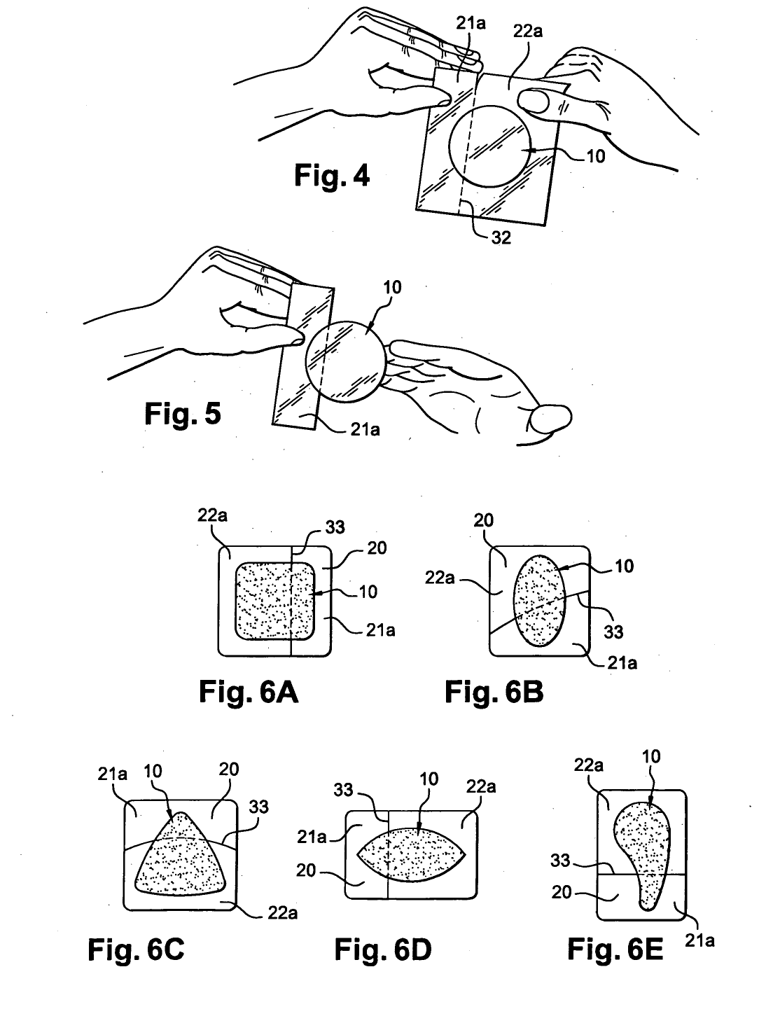

To use the article according to the invention, the user grasps each portion 21a and 22a of the sheet by each hand. The larger portion 22 of the sheet 20 can then be detached so as to expose a large part of the adhesive surface of the applicator, as illustrated in FIG. 4. The fingers can then be placed on the exposed adhesive layer, as can be seen in FIG. 5. Finally, the second portion 21 of the sheet can be detached so that the applicator 10 is held only by the fingertips. The applicator 10 is then in place on the user's fingers, and the user can then apply the product to the area to be treated without ever touching the application surface beforehand.

In the foregoing detailed description reference is made to preferred embodiments of the invention. It is evident that variants can be proposed without departing from the invention as claimed herebelow.

Obviously, numerous modifications and variations of the present invention are possible in light of the above teachings. It is therefore to be understood that, within the scope of the appended claims, the invention may be practiced otherwise than as specifically described herein.

1. An article for the application of a product comprising:
at least one applicator including a first face having an application surface and a second face, opposite the first, at least partially covered by an adhesive layer, the first face holding the product to be applied;
a backing sheet covering the adhesive layer, before a first use, wherein the backing sheet includes a weakened zone or a cutout extending at least partially beneath the applicator and enabling the sheet to be separated into at least two parts, and wherein the backing sheet projects beyond the applicator on at least one part of a periphery of the applicator on each side of the weakened zone or the cutout.

2. An article according to claim 1, wherein the backing sheet projects beyond the applicator around its entire periphery.

3. An article according to claim 1, wherein the backing sheet includes a silicone-treated paper.

4. An article according to any of claim 1, wherein the cutout or weakened zone extends along a line.

5. An article according to claim 1, wherein the cutout or weakened zone includes a line that is cut in a discontinuous manner.

6. An article according to claim 1, wherein the cutout or weakened zone includes a line that is cut in a continuous manner.

7. An article according claim 1, wherein the weakened zone or the cutout extends along a straight line.

8. An article according to claim 1, wherein the weakened zone or the cutout extends along a curved line.

9. An article according to claim 1, wherein the applicator is impregnated with the product to be applied.

10. An article according claim 1, wherein the application surface is coated with a layer of product to be applied.

11. An article according to claim 1, wherein the product is a cosmetic product.

12. An article according claim 1, wherein the applicator includes at least one material selected from the group consisting of a porous material and a fibrous material.

13. An article according to claim 1, wherein the applicator includes at least one material selected from the group consisting of a thermoplastic foam material, a sponge material, a felt material, a non-woven material, and a woven material.

14. An article according to claim 1, wherein the applicator is formed of natural fibers.

15. An article according to claim 1, wherein the applicator is made of an elastically deformable material.

16. An article according to claim 1, wherein the applicator includes a multi-layer structure.

17. An article according claim 1, wherein the application surface is covered with at least one material selected from the group consisting of a flock material, a non-woven material and a woven material.

18. An article according to claim 1, wherein the adhesive layer includes a hypoallergenic adhesive.

19. An article according to claim 1, wherein the adhesive layer extends over the entire second face of the applicator.

20. An article according to claim 1, wherein the adhesive layer partially covers the second face of the applicator.

21. An article according to claim 1, wherein a cross-section through the thickness of the applicator has a flattened shape, and wherein the adhesive layer extends substantially parallel to the application surface.

22. An article according to claim 1, wherein a cross-section through the thickness of the applicator has a convex shape at least in a region of the application surface.

23. An article according to claim 1, wherein the applicator has a circular shape.

24. An article according to any of claim 1, wherein the applicator has a non-circular shape.

25. An article according to claim 1, wherein the applicator has one of a generally triangular, polygonal, oval, drop or almond shape.

26. An article according to claim 1, wherein the article includes several applicators.

27. An article according to claim 1, wherein before a first use, the application surface is covered by a film reversibly attached to a portion of the backing sheet projecting beyond the applicator.

28. An article according to claim 1, wherein the product held by the applicator includes at least one product selected from the group consisting of a disinfectant product, a sunscreen, a moisturizing product, an anti-wrinkle product, a nail varnish, a foundation, a blusher, an eyeshadow, a lip color, a makeup remover, a hair care product, a hair coloring product, a deodorant, an antiperspirant product, and a perfume.

29. An article according to claim 1, wherein the product held by the applicator includes a makeup product.

30. A method of applying a cosmetic product by means of an article as recited in claim 1, comprising:
grasping the article on both sides of the weakened zone or cutout by the parts of the backing sheet;
separating the two parts of the sheet by detaching one of the two parts of the applicator so as to partially expose the adhesive layer;
placing at least one finger on the exposed adhesive layer;
pulling the other of the two parts of the backing sheet off the applicator; and
appling the application surface to the area to be treated.

31. An article according to claim 1, wherein the backing sheet is provided by a continuous backing sheet which is separated into said two parts by said weakened or cutout formed in said continuous backing sheet.

32. An article according to claim 31, wherein a plurality of articles are provided on said continuous backing sheet and wherein at least one weakened or cutout line is provided in said continuous backing sheet for each applicator.

33. An article as recited in claim 1, wherein one of the two parts of said backing sheet covers a larger portion of said second face of the applicator than the other of said two parts.

34. An article according to claim 1, wherein the backing sheet includes a plurality of gripping portions including at least a first gripping portion associated with one of said two parts and projecting beyond the periphery of said applicator and a second gripping portion associated with the other of said two parts and projecting beyond the periphery of said applicator, and wherein remaining portions of said backing sheet other than said plurality of gripping portions substantially follow the periphery of the applicator.

35. An article according to claim 1, wherein a film covers said applicator and wherein said film includes notched portions to allow access to said backing sheet to grip said two parts of said backing sheet.
